(19) United States
(12) Patent Application Publication
(10) Pub. No.: US 2004/0167714 A1
(43) Pub. Date: Aug. 26, 2004

(54) Personal navigation device with orientation indicator

(76) Inventor: Phil Macphail, Cambridge (GB)

Correspondence Address: KENYON & KENYON, 1500 K STREET, N.W., SUITE 700, WASHINGTON, DC, 20005, US

(21) Appl. No.: 10/370,630

(22) Filed: Feb. 24, 2003

(51) Int. Cl. G01C 21/00

(52) U.S. Cl. 701/213; 342/357.06

(57) ABSTRACT

A personal navigation device and method are disclosed. The device and method make use of an integrated electronic compass to simplify data transfer to the user thereby simplifying the navigation process. In use, data provided by the electronic compass is used to orient a displayed map relative to the orientation of the personal navigation device. Alternatively, the data provided by the electronic compass is used to rotate an icon indicative of the position of the user in which the icon rotates in response to a change of orientation of the user. In a simplified device, the electronic compass data is used to indicate the direction and displacement of a series of predetermined waypoints relative to the current position of the personal navigation device.

### FIELD OF THE INVENTION

This invention relates to navigation systems incorporating global positioning systems (GPS) and more particularly to navigation systems that are designed to be handheld.

### BACKGROUND OF THE INVENTION

Navigation systems are now widely available for a variety of different luxury automobiles. These navigation systems rely on global positioning system (GPS) data, extensive navigation databases, and other sensor data. The implementation of a navigation system for an automobile is simplified because the vehicle is assumed to be traveling forward, unless of course the gear selector is set to reverse. A typical vehicle navigation system additionally incorporates sensors that determine the direction that the car is facing. Thus, the navigation system merely needs to inform the driver of the automobile when to turn left or right.

Recent developments have provided more affordable GPS devices that provide a navigation system for an individual. In U.S. Pat. No. 6,124,826, Garthwaite et al. describe a portable communications device that establishes a wireless communication link with a remote navigation computer. In a proposed embodiment, the portable communications device is a portable digital assistant with an integrated GPS. The user specifies a desired destination to a remote computer, the remote computer having access to an extensive navigation database. The remote computer then provides data to the digital assistant, the data for providing a map. The map shows the location of the portable digital assistant and the location of the desired destination.

Although there are many people who are accustomed to using a map for navigation many people have difficulty following a map. For example an experienced navigator will typically hold a map in a normal orientation. When turning 90° to the right the experienced navigator does not need to turn the map by a corresponding angle. Many individuals are not as accustomed to using a map this way and consequently they rotate the map such that they are facing a direction that is parallel to their direction on the map.

Clearly, if a map is provided on the display of a personal navigation device it is not practical to rotate the device in response to a change in orientation. Additionally, a personal navigation device may also serve as a cellular telephone. If the user brings the phone to their ear, the orientation of the user may be lost. Indeed there are many possible distractions that can easily cause the user to lose their orientation with regards to a map on a display.

It would be beneficial to provide a personal navigation device in which the orientation of a map provided on a display of the device is provided in an orientation that is easily discernible by the user.

### SUMMARY OF THE INVENTION

The invention teaches a portable navigation device comprising:

a GPS receiver for receiving GPS information and determining a location corresponding to the GPS information;

a compass for determining orientation information of the personal navigation device;

a first memory for storing map data;

a processor for processing a map transformation and for storing transformed map data in the first memory, the map transformation being a function of the orientation information and the GPS information, the map transformation for transforming map data, the map transformation supporting a change in scale and a rotation; and

a display for displaying a map corresponding to transformed map data.

Additionally, the invention provides a method of displaying a map on a portable navigation device, the method comprising:

receiving position data from a GPS receiver;

receiving compass data from a compass;

transforming a set of map data in dependence upon compass data; and

providing transformed map data to display.

Further, the invention also describes a personal navigation device comprising:

a GPS receiver for providing GPS position data;

an electronic compass for providing direction data;

a memory for storing position data corresponding to a plurality of waypoints;

a processor for comparing GPS position data and direction data to position data corresponding to the plurality of waypoints; and

a display for indicating the direction of at least two of the plurality of waypoints.

### BRIEF DESCRIPTION OF THE DRAWINGS

The invention is described with reference to the drawings in which:

FIG. 1 is a schematic diagram of a portable navigation system according to the invention;

FIG. 1a is a representative view of a display panel showing a map in which the location of the user is shown facing a leading edge of the map;

FIG. 1b is a representative view of a display panel showing a map with a direction indicator;

FIG. 2 is a schematic diagram of a portable navigation system according to the invention in the form of a cellular telephone, and;

FIG. 3 is a simplified view of a display of a portable navigation system according to the invention featuring arrows indicating the direction and distance of a waypoint and a destination.

### DETAILED DESCRIPTION OF THE INVENTION

The use of a personal digital assistant as a navigation device has been explored in a variety of patents. In U.S. Pat. No. 6,124,826, Garthwaite et al. describe a personal navigation system that provides a desired destination and GPS data corresponding to a current location to a remote traffic computer. The remote traffic computer then provides navigation data including map data to the personal navigation device. Garthwaite et al. suggest that the remote computer continue communication with the personal navigation device. Unfortunately, the use of this prior art device is compromised when the personal navigation system is unable to achieve a cellular communications link at specific times. The navigation device according to Garthwaite et al. is described for use with a pedestrian as well as in a motor vehicle. The device supports a first mode of operation in which audio instructions are provided to the user and a second mode in which a local map is displayed. The device will also provide arrows instructing the user to turn left or right. Clearly, the instructions to turn left or right are useful when traveling on a road. In a personal navigation system for a pedestrian this is often inadequate. This prior art device relies heavily on the GPS receiver for determining the current location. Unfortunately, this represents a problem as individuals carrying such a device will enter areas that inhibit the reception of GPS signals from the satellites. For example, if a user walks between two tall buildings, it is unlikely the receiver proximate the user will be able to receive three signals from three separate GPS satellites. In this situation, the prior art device must be repositioned away from the buildings in order to receive GPS signals.

In Swiss patent CH691337 by Hauke, a personal navigation device is described in the form of a wristwatch. The device includes a GPS receiver, an electronic compass and memory for storing waypoints. In use, the device is activated and a waypoint is selected. An arrow is displayed pointing in the direction of the selected waypoint. A current distance from the selected waypoint is also displayed. The user is able to display one arrow indicative of one waypoint. The device is capable of storing a plurality of waypoints for providing a navigation route. Unfortunately, this device is not easily programmed. For example, one method of selecting a waypoint is to go to the waypoint and activate an input to store waypoint information provided by the GPS receiver. Clearly, in many cases this is not an option. Another method of programming the wristwatch is to have it interface with an external computing system. It is suggested that such a computing system be provided in an automobile. In either case, programming the device would not be convenient for many users.

In many of the prior art hand held portable navigation devices, a display is used to provide a map of local surroundings. As the user moves, the map is updated. In these devices, the map scrolls in response to a change in location as determined by the GPS receiver. Additionally, in some devices the scale of the map varies in response to the distance to a waypoint. Unfortunately, these navigation devices do not rotate the map as the navigation device rotates. Generally, people experienced in navigation are accustomed to using a map without rotating the map as they change orientation. While some users are likely to be experienced in navigation it is likely that many are not and consequently, not being able to rotate the map will likely complicate the act of navigation and frustrate a novice user.

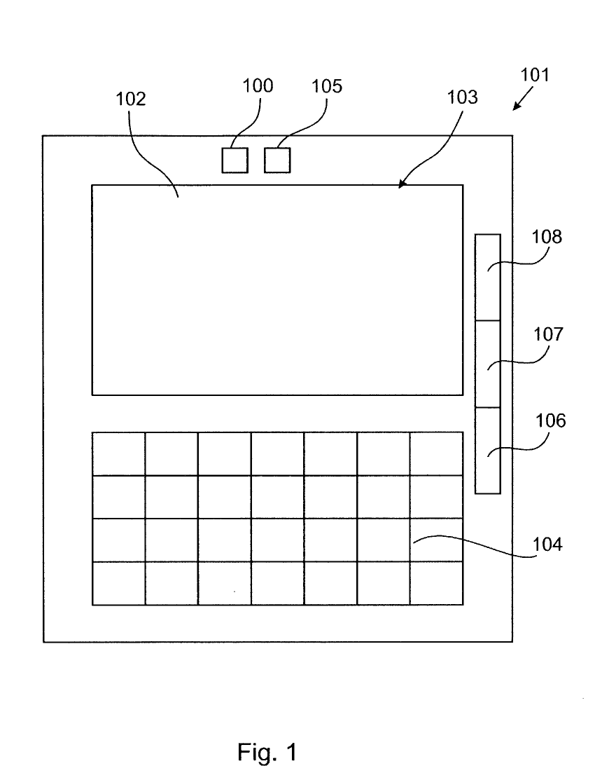

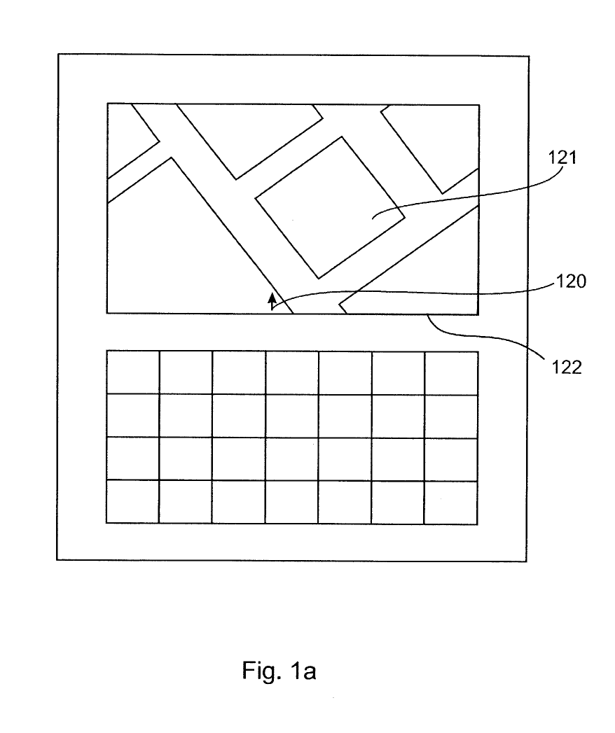

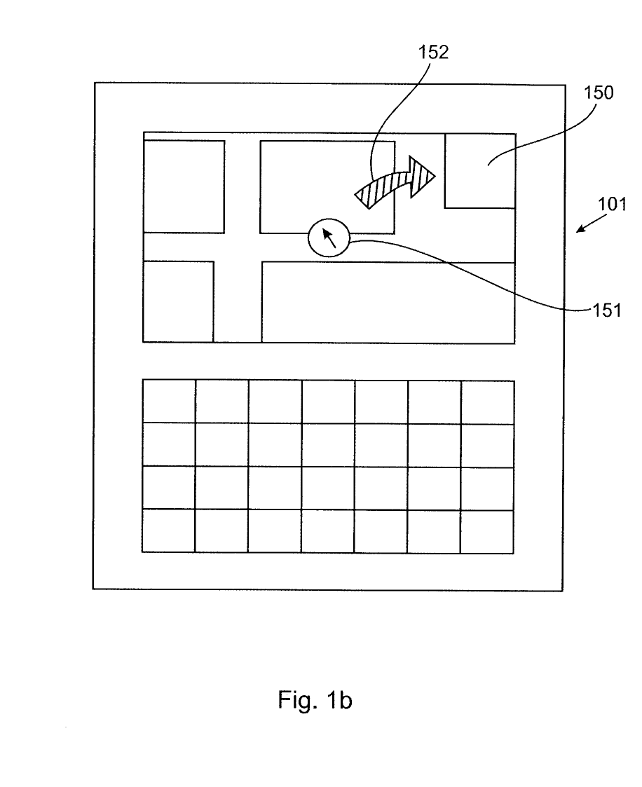

Referring to FIG. 1, in a first embodiment of the invention an electronic compass 100 is integrated with a personal navigation device 101. The personal navigation device 101 also includes a display 102, an input panel 104, a GPS receiver 105, a processor 106, a memory 107, and a wireless communication module 108. The input panel 104 is for providing information regarding a desired destination. The display 102 has a leading edge 103. In operation, a user provides data indicative of the desired destination to the personal navigation device 101 via the input panel 104. The personal navigation device 101 transmits a query to a remote computer via the wireless communication module 108. The query includes data indicative of the current position of the personal navigation device in addition to data indicative of the desired destination. The remote computer accesses a navigation database and determines an appropriate route from the current position to the desired destination. The computer then provides data to the personal navigation device 101 via the wireless communication module 108. The data is indicative of the local geographic features of a region including the current position and the desired destination. Optionally, additional data is provided regarding geographic features of other areas proximate the route. The user is instructed to point the personal navigation device 101 straight ahead in order to establish the orientation of the user. The electronic compass 100 is then used to verify the orientation of the personal navigation device 101. This orientation is compared to a direction associated with the route at the position of the user. The user is optionally instructed to turn in a direction parallel to a first portion of the route. The user is then instructed to proceed along the route. As the user proceeds along the route, a map of the local surrounding is provided on the display 102. The map scrolls in response to changes in the sensed GPS location of the personal navigation device 101. Additionally, the map is oriented such that an indicator indicative of the position and orientation of the user is always approaching the leading edge 103 of the display 102. Thus, as the personal navigation device 101 is rotated the map is rotated. This is highly advantageous as it permits the user to briefly view the display without rotating the navigation device or guessing if the direction the user is currently facing is appropriate. Referring to FIG. 1a, a display output is shown featuring an arrow 120 indicative of the current location and orientation of the personal navigation device, a trailing edge of the display 122 and some buildings 121. Since the display is assumed to be oriented in the direction that the user is facing the display is configured with the arrow 120 proximate the trailing edge 122 of the display. Thus, the limited area of the display is not wasted showing areas that the user does not see. This simplifies the recognition of the various landmarks proximate the user. Thus, the device displays geographic information consistent with the field of view of the user.

In an alternative to the first embodiment of the invention, an arrow indicative of the user direction is shown on the display 102, the direction that the arrow points corresponds to data obtained from the electronic compass 101. In this embodiment of the invention, the map provided on the display 102 scrolls in a manner corresponding to the displacement of the personal navigation device; however, the displayed map does not turn relative to the personal navigation device. Referring to FIG. 1b, a display 150 providing a map is shown. The map includes a first arrow 151 indicative of the position and orientation of the personal navigation device 101 and an indicator 152 corresponding to the direction of the desired destination. In this embodiment of the invention, the user is permitted to rotate the map and fix the orientation of the map. This permits a person of skill in the art of navigation to use the device as they would a more conventional map. Clearly, the device according the alternative embodiment of the invention is optionally used to display the map in a manner described with respect to the first embodiment of the invention. Thus, the device according to the alternative embodiment of the invention comprises an input port for selecting a method of orienting the map on the display 102.

Optionally, since the location, time and orientation relative to magnetic north are known an accurate orientation to true north is calculated.

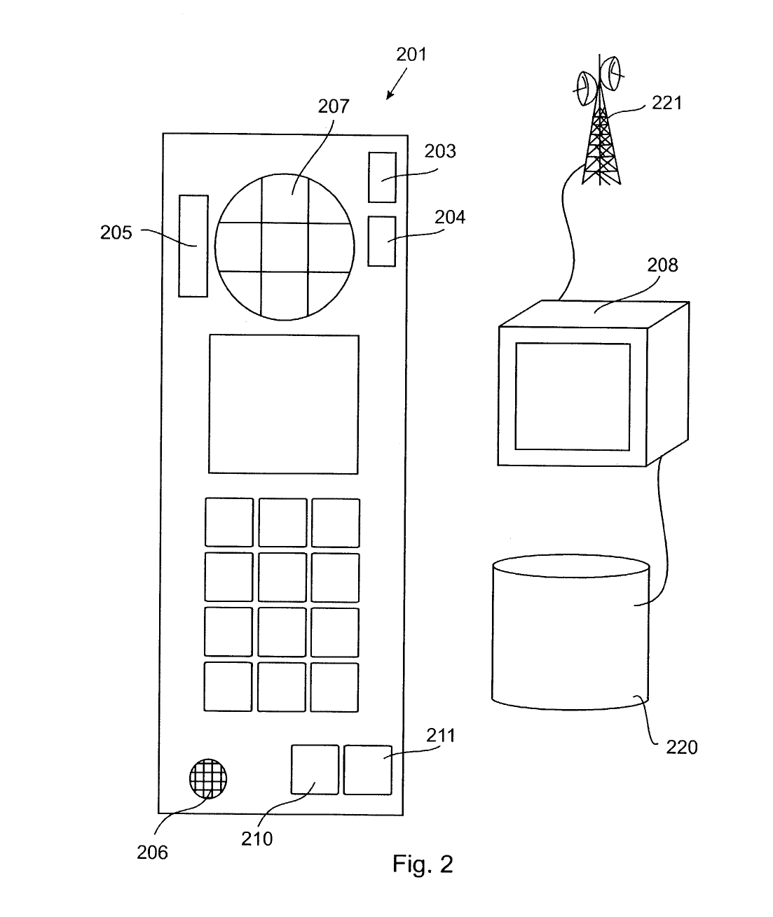

Referring to FIG. 2, in another embodiment of the invention a personal navigation device 201 is provided. The personal navigation device 201 has an electronic compass 203, a GPS receiver 204, a wireless communication module 205, an input port 206, an output port 207, a processor 210 and a memory 211. In this embodiment, the personal navigation device shown is a cellular telephone. This personal navigation device 201 is for use with a remote navigation computer 208, the remote navigation computer 208 having access to a navigation database 220 as well as a wireless communication link 221. In use, a user makes a cellular telephone call to a navigation service and specifies a desired destination. The telephone automatically provides GPS data and compass data to the navigation service. The navigation service queries the remote navigation computer 208 to provide an appropriate route. The remote navigation computer 208 compares the current location, the desired destination and the navigation database 220. Having determined an appropriate route, the remote navigation computer 208 provides simple route information to the personal navigation device 201. When the route information has been successfully downloaded, the wireless communication link with the remote navigation computer is optionally terminated. The route information comprises a series of waypoints and their order, the last of these waypoints being the desired destination. The personal navigation device 201 requests the user to orient himself with the electronic compass 203 and proceed to the first waypoint. When the user is within a predetermined distance of a waypoint, he is instructed to turn to face the next waypoint and proceed. The user is instructed to point the portable navigation device in a fixed orientation relative to their displacement, i.e. on their belt or in their pocket for example. Clearly, when the personal navigation device 201 is located in the pocket of the user's clothing it may be necessary to provide an earphone with the device to ensure that the user can accurately hear the instructions provided by the personal navigation device 201. Additionally, when the device is located in a pocket of the user's clothing it is uncertain if the device is tilted relative to the user. In order to overcome this problem the electronic compass is optionally a compass module supporting three electronic compasses each for monitoring the intensity of a local magnetic field perpendicular to the others. Thus, regardless of the tilt of the personal navigation device, the orientation of the device relative to a local magnetic field is easily established. Once the personal navigation device is oriented relative to the user, in a pocket for example, this orientation is stored. The user is oriented relative to a waypoint, the personal navigation device is placed in an active orientation mode. Thus, in the event that the user is unable to proceed in a forward direction, the personal navigation device is able to provide accurate directions. For example, in a severe snowstorm, it is often the case that a user is unable to proceed directly into the oncoming wind. Thus, the user may proceed sideways or even backwards. Clearly, under such conditions a user should be very careful to avoid injury. Regardless the personal navigation device is able to provide accurate audio directions that are consistent with the orientation of the user. For example, if a user is facing south while heading north, the instruction to turn left corresponds to turning east. That said, a prior art navigation system that relies on dead reckoning or user orientation assumptions would likely presume that the user is facing the direction they are going, which is not the case. Consequently, the prior art system would instruct the user to turn right in order to face east resulting in the user heading westward. Clearly, in emergency situations it is critical that someone in need of navigation instructions be given instructions that are unambiguous. Additionally, in a more sophisticated version of the present embodiment, the personal navigation device informs the user of any possible hazards in their area. For example, if the user deviates somewhat from the proposed navigation route and the personal navigation system senses that the user is unable to face their direction of travel then the personal navigation system will inform the user of any proximate hazards. For example, a user is lost in a park during a snowstorm, a nearby stream is not yet frozen and the user is proceeding near the edge of the stream in accordance with a navigation route. The personal navigation system senses that the user is proceeding in a direction other than the direction that he is facing and modifies the navigation route to be further from the stream. Thus, the user is easily redirected should the user deviate towards the stream. If the user deviates towards the hazard, the personal navigation system optionally provides a warning to the user further optionally describing the nature of the hazard.

Additionally, when the personal navigation device has, for example, been mounted on a user's belt it may be prone to moving about the belt somewhat due to the movement of the user or perhaps being inadvertently pushed by the user's arm. In either case, if the change in orientation of the personal navigation device is relatively minor, a deviation between the direction of movement of the user as sensed by the compass and the direction of movement of the user as determined by a dead reckoning algorithm using GPS data will occur. When this happens, the personal navigation system modifies a stored orientation of the personal navigation device relative to the user. This provides enhancement to the accuracy of the compass data.

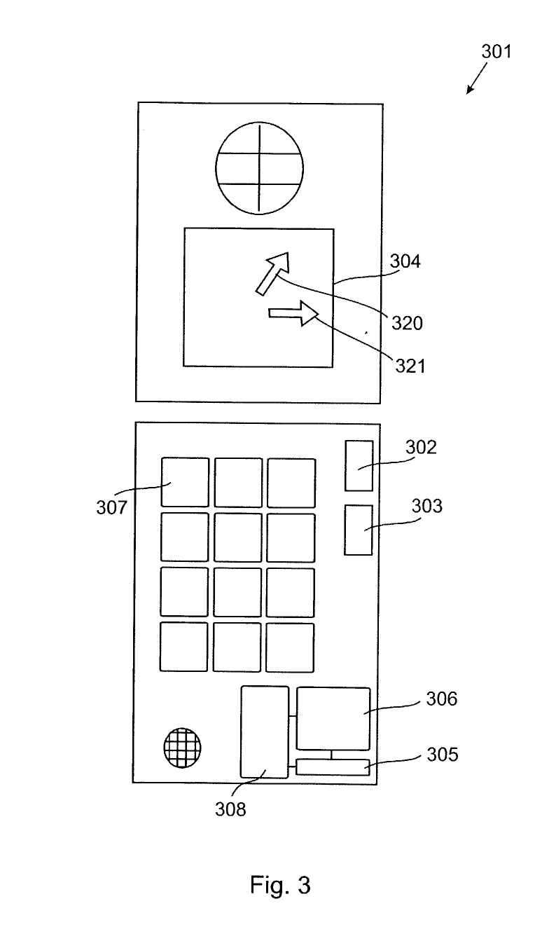

Referring to FIG. 3, in another embodiment of the invention a personal navigation device 301 is shown. The personal navigation device 301 includes a GPS receiver 302, a compass 303, a display 304, a processor 305, a memory 306, an input keypad 307 and a navigation database 308. In use, a user specifies a desired destination by providing data to the input keypad 307. When the desired destination has been specified it is provided to the processor 305 along with the current position of the personal navigation device as provided by the GPS receiver 302. The processor 305 then accesses data in the navigation database 308 and determines an appropriate route. The route comprises a plurality of waypoints, each of which is stored in memory. The desired destination corresponds to the last of the waypoints. The route is a series of straight lines connecting the waypoints. When the route has been determined the user holds the personal navigation device 301 to make the display 304 easily visible. The display shows a first arrow 320 which points towards the next waypoint and a second arrow 321 pointing towards the desired destination. When the device is turned, a signal is provided from the compass 303 to the processor 305 and the processor 305 provides data indicative of a new first arrow 320 position and a new second arrow 321 position to the display 304. The display 304 then shows the first arrow 320 and the second arrow321 rotated accordingly such that it points in the general direction of the next waypoint and the desired destination respectively. In the event that the personal navigation device 301 is not properly oriented, for example, if the display 304 of the personal navigation device 301 is not pointed generally upwards then the user is instructed to remedy this situation. In the event that the user deviates substantially from the navigation route a new navigation route is generated. This embodiment of the invention is advantageous because it provides the user autonomy without providing instructions to return to the navigation path whenever a deviation is sensed. Thus, a tourist using such a device might be distracted and move off the path to take some photographs or enter a restaurant is not pestered by warnings that they are no longer on the navigation route. Clearly, when so distracted, the intent of the user is not to follow the navigation route so informing them that they are doing so is merely an annoyance. Additionally, since a second arrow 321 is provided pointing towards the desired destination the user may recognize the destination prior to reaching the last few waypoints. This also provides more autonomy for the user of the personal navigation device 301 as the user is now able to look for a landmark corresponding to the desired destination. Clearly, once the desired destination is visible the user may choose to deviate from the navigation route and try another route that is apparent. The display 304 optionally includes a distance indicator that informs the user of the distance to the waypoint.

Optionally, the compass 303 comprises three electronic compasses, each mounted at a right angle to the other two. This permits the device to effectively determine the direction of magnetic north even when the device is not properly oriented relative to the magnetic field of the earth. Additionally, the use of arrows to indicate direction is meant to be purely illustrative of an embodiment of the invention. Clearly, any figure from which a direction can be accurately determined is optionally used instead. Such a figure will be stored as figure data in a memory of the device and transformed accordingly for display.

In an embodiment, the waypoints are provided in groups such that the desired destination is not a last waypoint provided to the device for a portion of the route, the last waypoint of the last portion of the route being the desired destination.

Numerous other embodiments of the invention may be envisioned without departing from the spirit or the scope of the invention.

What is claimed is:

1. A portable navigation device comprising:
a housing;
a GPS receiver disposed within the housing for receiving GPS information and determining a location corresponding to the GPS information;
a compass disposed within the housing for determining orientation information of the personal navigation device;
a first memory disposed within the housing for storing map data;
a processor disposed within the housing for processing a map transformation and for storing transformed map data in the first memory, the map transformation being a function of the orientation information and the GPS information, the map transformation for transforming map data, the map transformation supporting a change in scale and a rotation; and
a display disposed within the housing for displaying a map corresponding to transformed map data.

2. A portable navigation device according to claim 1, wherein the compass is an electronic compass.

3. A portable navigation device according to claim 2, wherein the electronic compass comprises a set of solid-state compasses each of the solid-state compasses having a fixed orientation relative to the portable navigation device.

4. A portable navigation device according to claim 1, wherein the map transformation is a function of orientation information, GPS information and time.

5. A portable navigation device according to claim 4, wherein the map transformation includes a rotation thereof.

6. A portable navigation device according to claim 1, wherein the map transformation includes a rotation thereof.

7. A method of displaying a map on a portable navigation device, the method comprising:
receiving position data from a GPS receiver;
receiving compass data from a compass;
transforming a set of map data with a map transformation in dependence upon compass data; and
providing transformed map data to a display.

8. A method according to claim 1, wherein the compass is an electronic compass.

9. A method according to claim 8, wherein the electronic compass comprises a set of at least solid-state compasses each of the solid-state compasses having a fixed predetermined orientation relative to the other solid-state compasses.

10. A method according to claim 1, wherein the map transformation is a function of orientation information, GPS information and time.

11. A method according to claim 10, wherein the map transformation includes a rotation thereof.

12. A method according to claim 1, wherein the map transformation includes a rotation thereof.

13. A method of displaying a map according to claim 7, wherein the step of transforming a set of map data comprises:
receiving a set of map data;
receiving a set of figure data;
rotationally transforming the figure data in accordance with compass data, and;
superimposing the figure data on the map data.

14. A personal navigation device comprising:
a housing;
a GPS receiver disposed within the housing for providing GPS position data;
an electronic compass for providing direction data;
a memory disposed within the housing for storing position data corresponding to a plurality of waypoints;
a processor disposed within the housing for comparing GPS position data and direction data to position data corresponding to the plurality of waypoints; and,
a display disposed within the housing for indicating the direction of at least two of the plurality of waypoints.

15. A personal navigation device according to claim 14, comprising memory having stored therein data corresponding to instructions for performing the steps of:
determining a corresponding distance to each of the position data and for providing a signal to the display; wherein the display is for indicating the distance of one of the plurality of waypoints.

16. A personal navigation device according to claim 14, comprising a wireless transceiver for sending and receiving position data.

17. A personal navigation device according to claim 16, wherein the wireless transceiver is a cellular telephone.

18. A personal navigation device comprising
a processor;
a display for showing a map, said display coupled to said processor;
means for detecting the orientation of the earth's magnetic field at said personal navigation device;
a memory coupled to said processor, said memory storing instructions adapted to be executed by said processor to orient the map shown on said display according to the detected orientation of the earth's magnetic field.

19. The personal navigation device of claim 18, wherein the personal navigation device includes a wireless transceiver for sending and receiving position data.

20. The personal navigation device of claim 18, wherein the personal navigation device includes a cellular telephone.
